(19) United States
(12) Patent Application Publication
(10) Pub. No.: US 2020/0236025 A1
(43) Pub. Date: Jul. 23, 2020

(54) TEST AND MEASUREMENT INSTRUMENT WITH BUFFER MODEL DELAY COMPENSATION

(71) Applicant: Tektronix, Inc., Beaverton, OR (US)

(72) Inventor: Michael S. Overton, Beaverton, OR (US)

(73) Assignee: Tektronix, Inc., Beaverton, OR (US)

(21) Appl. No.: 16/252,497

(22) Filed: Jan. 18, 2019

(51) Int. Cl. H04L 12/26; H04L 12/835

(52) U.S. Cl. CPC H04L 43/0894; H04L 47/30; H04L 43/50; H04L 43/16

(57) ABSTRACT

A test and measurement instrument, including one or more ports configured to receive a stream of packets from a transmitter through a network component, each packet including a timestamp; and one or more processors. The one or more processors are configured to select a buffer model, the buffer model including one or more validation thresholds for a buffer fullness, determine a network delay based on the timestamp in each packet and when the packet was received at the one or more ports, and compensate the buffer model based on the network delay to determine a buffer fullness value based on the stream of packets. The test and measurement instrument also includes a display to display an indication of whether the transmitter complies with the selected buffer model, so a user can confirm whether a transmitter being tested complies with applicable standards.

### FIELD OF THE INVENTION

This disclosure is directed to systems and methods related to test and measurement systems, and in particular, to test and measurement systems for determining whether a transmitter complies with a particular standard.

### BACKGROUND

The Society of Motion Picture and Television Engineers (SMPTE) has a standard, SMPTE 2110-21, which, in addition to other specifications, defines a model for a buffer in a receiver of a network based video system. Transmitters are required to ensure that their output stream complies with the limits in its respective buffer model. Transmitters in compliance with the limits in the buffer model allow a receiver to create a continuous real-time output from the stream. The buffer model, however, is only specified, and therefore only applicable, directly at the output of the transmitter. Many times, a measurement port is not readily available in a device under test to directly measure the output of the transmitter, ultimately making the test or measurement inaccurate.

Embodiments of the disclosure address these and other deficiencies of the prior art.

### BRIEF DESCRIPTION OF THE DRAWINGS

Aspects, features and advantages of embodiments of the present disclosure will become apparent from the following description of embodiments in reference to the appended drawings in which:

FIG. 1 is a block diagram of an example test and measurement instrument according to embodiments of the disclosure.

FIG. 2 is a system diagram that includes an example of a Virtual Receiver Buffer model, as set out in SMPTE 2110-21.

FIG. 3 is a timing diagram an example of a gapped packet readout schedule.

FIG. 4 is a timing diagram an example of a linear packet readout schedule.

FIG. 5 is a system block diagram illustrating an example of a measurement location for a transmitter on a network system.

FIG. 6 is another system block diagram illustrating another example of a measurement location for a transmitter on a network system.

FIG. 7 is a flowchart illustrating example operations of the test and measurement instrument of FIG. 1, according to some embodiments of the disclosure.

### DESCRIPTION

Embodiments of the disclosure include a test and measurement instrument that is configured to determine whether a transmitter complies with the limits of a buffer model, as set out in the standard, without measuring directly at the physical output of the transmitter. As mentioned above, the buffer model set out in the SMPTE Standard 2110-21, which is incorporated by reference herein in its entirety, is applicable only at the output of the transmitter. If the stream of data sourced by the transmitter has passed through another network device, such as a switch, then the delay in the network device will shift the measured buffer fullness toward the empty limit. This is because packets the transmitter has emitted are delayed at the measurement point, and so some of the packets are not being accounted for yet. This may lead to inaccurate test results, as most devices connect to a network through a network device, and the measurement and monitoring ports should be able to connect to the device under test anywhere on that network. The test and measurement instrument as disclosed in embodiments below may connect at a different portion of the network, but still accurately measure the output of the transmitter to ensure it is complying with the buffer model.

Transmitters may come in different classes and there is a defined receiver buffer model for each class of transmitter. Although transmitters with tightly controlled output timing can be matched with receivers having smaller buffers, transmitters with a wide timing distribution typically drive into a receiver with a larger buffer.

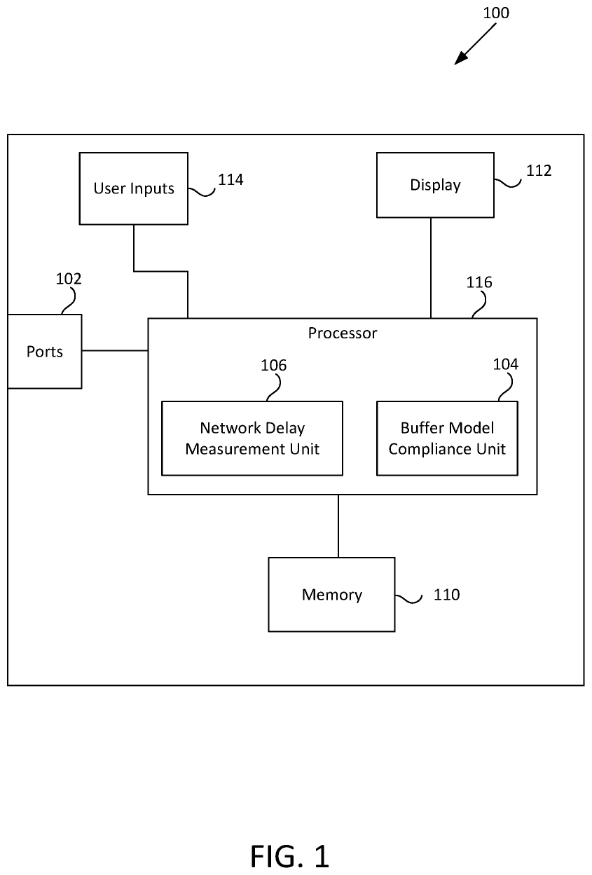

FIG. 1 is a block diagram of an example test and measurement instrument 100, such as a media monitoring and analysis platform, for implementing embodiments of the disclosure disclosed herein. The instrument 100 includes a plurality of ports 102 which may be any electrical signaling medium and may act as a network interface. Ports 102 may include receivers, transmitters, and/or transceivers. The ports 102 are connected to a network to receive data from a device under test, such as a transmitter. The ports 102 are coupled with one or more processors 116. The one or more processors 116 may include a buffer model compliance unit 104 and a network delay measurement unit 106, which may receive one or more inputs from the ports 102 to determine an amount of network delay and determine whether a connected transmitter complies with a corresponding buffer model. Although only one processor 116 is shown in FIG. 1 for ease of illustration, as will be understood by one skilled in the art, multiple processors of varying types may be used in combination, rather than a single processor 116.

The ports 102 can also be connected to a measurement unit in the test instrument 100, not depicted. Such a measurement unit can include any component capable of measuring aspects (e.g., voltage, amperage, amplitude, etc.) of a signal received via ports 102. The packet pipeline depicted by ports 102 through a processor and/or buffer model compliance unit 104 can include conditioning circuits, an analog-to-digital converter, and/or other circuitry.

The buffer model compliance unit 104 may be implemented as any processing circuitry, such as an application specific integrated circuit (ASIC), a digital signal processor (DSP), a field programmable gate array (FPGA), etc. In some embodiments, the buffer model compliance unit 104 may be configured to execute instructions from memory 110 and may perform any methods and/or associated steps indicated by such instructions. Memory 110 may be implemented as processor cache, random access memory (RAM), read only memory (ROM), solid state memory, hard disk drive(s), or any other memory type. Memory 110 acts as a medium for storing data, computer program products, and other instructions, and providing such data/products/instruction to the buffer model compliance unit 104 for computation as desired. Memory 110 also stores measured signal responses (e.g. waveforms), timestamps, buffer models as set forth in the SMPTE standard discussed above, and/or other network data for use by the processor 116.

User inputs 114 are coupled to the buffer model compliance unit 104. User inputs 114 may include a keyboard, mouse, trackball, touchscreen, and/or any other controls employable by a user to interact with the buffer model compliance unit 104 via a GUI on a display 112. The display 112 may be a digital screen, a cathode ray tube based display, or any other monitor to display test results, timestamps, packet time lines, or other results to a user as discussed herein. While the components of test instrument 100 are depicted as being integrated with test instrument 100, it will be appreciated by a person of ordinary skill in the art that any of these components can be external to test instrument 100 and can be coupled to test instrument 100 in any conventional manner (e.g., wired and/or wireless communication media and/or mechanisms).

In some embodiments of the disclosure, the test and measurement instrument 100 may include a separate processor (not shown) connected to the buffer model compliance unit 104. In some embodiments, the buffer model compliance unit 104 may connect to the memory 110, display 112, and user inputs 114 through the separate processor, as will be understood by one skilled in the art.

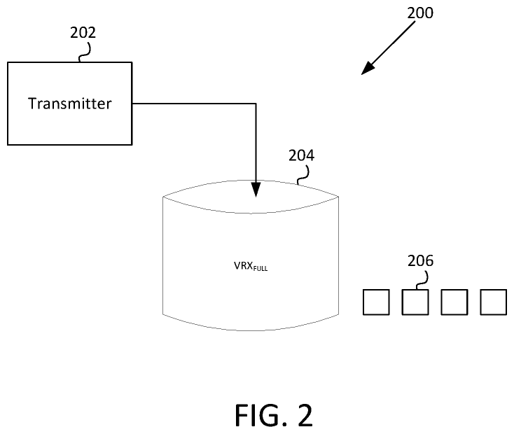

The SMPTE standard 2110-21 includes a buffer model that outlines a standard to which transmitters connected to a network are to comply. To be in compliance with the standard, real-time transport protocol (RTP) transmitters must ensure that their sequence of actual transmissions of packets, as measured at the output of the transmitter, passes the Virtual Receiver Buffer Model 200 in the standard at all times and in all operating configurations. The Virtual Receiver Buffer Model 200 is illustrated in FIG. 2. In the standard, as mentioned above, the model is applied at the output of the transmitter, before any network-induced delivery impairments.

The Virtual Receiver Buffer Model 200 include a transmitter 202 that outputs packets of data. Packets from the transmitter enter a leaky bucket 204, having a capacity VRX_{FULL} at the instant they are emitted from the transmitter 202. The Virtual Receiver Buffer Model 200 assume that packets enter and exit the leaky bucket 204 simultaneously.

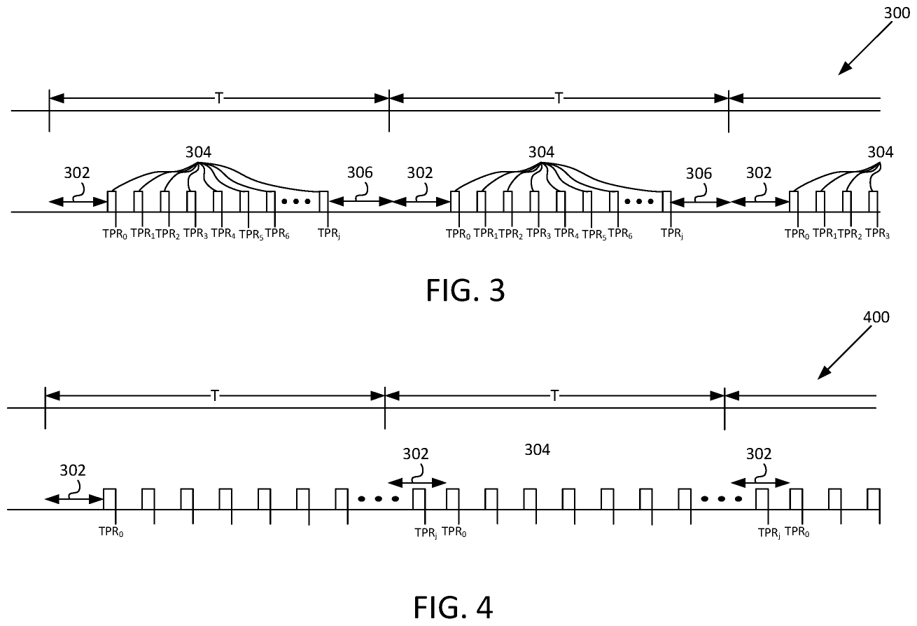

The value VRX_{FULL} represents the capacity of the Virtual Receiver model's buffer. This value constrains the number of outstanding packets between the transmitter's 202 actual transmission times and the Virtual Receiver's drain schedule. Packets 206 should drain out of the leaky bucket 204 at a particular time, TPRⱼ, based on a respective packet readout schedule (PRS), as discussed below with respect to FIGS. 3 and 4. Different types of transmitters will have different VRX_{FULL} values. The transmitter 202 should ensure that the leaky bucket 204 does not overflow, and that a particular packet, is available in the leaky bucket 204 no later than the particular time it is supposed to be drained out of the leaky bucket 204.

There are two types of packet readout schedules—a gapped PRS 300 and a linear PRS 400. FIG. 3 illustrates a gapped PRS and FIG. 4 illustrates a linear PRS. Starting with the gapped PRS of FIG. 3, a frame of data is sent during a time period T. An offset 302 may be provided before a first packet 304 of data is sent for a frame. Each frame of data may contain j packets 304, where j is greater than or equal to one. Each packet of data is removed from the Virtual Receiver Buffer at time TPRⱼ. In the gapped PRS 300, a gap 306 is provided after the last packet 304 before the next time period T begins.

In the linear PRS 400, as seen in FIG. 4, the packets 304 are sent evenly, without any gaps, as seen in FIG. 3. That is, during time period T, packets 304 may be sent from the previous frame, as well as the current frame. The offset 302 still indicates the offset from the beginning of the period T until the first packet 304 of that frame, which is drained out of the leaky bucket 204 at TPR₀.

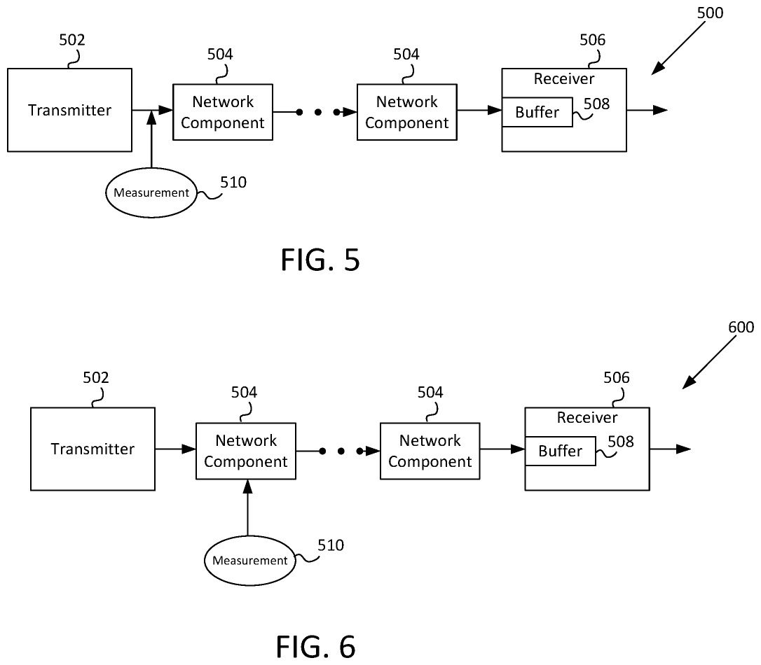

FIG. 5 illustrates the specified location for taking a measurement of the transmitter according to the SMPTE standard. As can be seen in FIG. 5, a network 500 may include a transmitter 502, one or more network components 504, such as one or more switches, for example, and a receiver 506. The receiver 506 may include a buffer 508. To ensure that the transmitter 502 is complying with a buffer model, ideally a test and measurement instrument would connect to the output of the transmitter 502 to measure 510 the output stream of data from the transmitter 502. However, as mentioned above, it is not always feasible to take a measurement directly at the output of the transmitter 502, since most transmitters 502 connect to the network 500 through a network component 504. Therefore, there is often not a convenient measurement port or physical access directly at the output of the transmitter 502. The network component 504 through which the transmitter 502 is connected to the network 500, such as a switch, produces a delay in the transmission of the packets output by the transmitter 502. This delay in the network component 504 shifts the measured buffer fullness (FIG. 2) toward the empty limit, since the packets are received at the test and measurement instrument 100 later than expected. The standard ST 2110 requires precision time protocol (PTP) to provide timing of the packets, and it is difficult to connect both the data flow and the PTP without using a switch, making it nearly impossible or extremely difficult to measure the output directly at the transmitter 502.

FIG. 6, conversely, illustrates a more practical location for taking a measurement, according to embodiments of the disclosure. This measurement may be taken at a network device 504, rather than at the output of the transmitter 502. Although the measurement is shown taken at a first network device 504, the measurement may be taken multiple places within the network, and the test and measurement instrument of the disclosure can determine whether the transmitter 502 complies with a buffer model, as if the measurement were taken at the output of the transmitter.

To test a transmitter, a buffer model is chosen based on the type of transmitter and the PRS used, such as the gapped PRS 300 or the linear PRS 400. A transmitter is tested using a test and measurement instrument to ensure that their transmission of packets comply with the chosen buffer model. However, as mentioned previously, when the output of the transmitter cannot be measured directly, a network delay is inherent to the system. This delay in packets results in packets in transit that have been output by the transmitter, but that have not yet been received at the test and measurement device, which results in the buffer model being inaccurate.

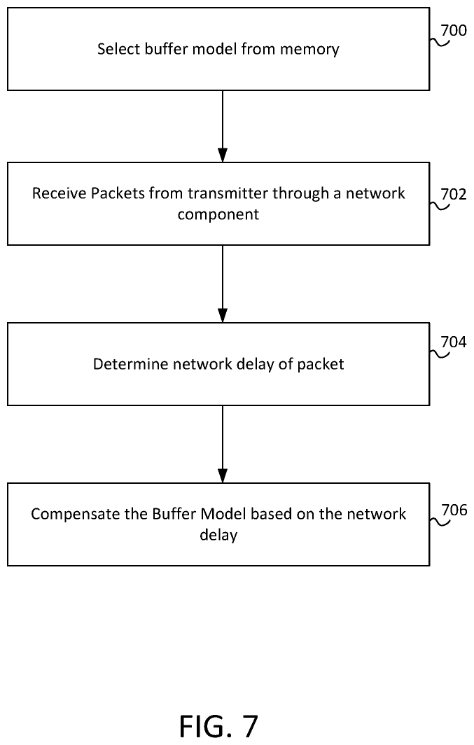

FIG. 7 illustrates a flow chart for determining whether the transmitter complies with a buffer model, when a measurement is taken through a network device 504, rather than at the output of the transmitter 502. The test and measurement device 100 connects to the network to measure the packets and ensure that the packets are being sent from the transmitter 502 as required by the buffer model set out in the standard.

Returning to FIG. 1, initially in operation 700, the buffer model compliance unit can select a buffer model stored in the memory 110 based on the type of transmitter 502 and receiver 506 in the network system. The buffer model compliance unit 104 may select the buffer model based on an input from a user through the user inputs 114. Once a buffer model has been selected, the one or more ports 102 of the test and measurement instrument may be connected to the network through one of the network devices 504. Packets from the transmitter 502 are received at operation 702 at the port 102 through the network component 504.

In operation 704, the network delay measurement unit 106 determines a network delay, or network error component, of the packet. This may be done, for example, by timestamping or otherwise recording the time the packet is received at the port 102 of the test and measurement instrument 100. The ST2110 standard mandates that a timestamp is added to the packet at the transmitter. The difference between these times is the amount of delay, or error component, of the packet from the transmitter 502.

Next, in operation 706, the buffer model compliance unit 104 compensates the selected buffer model so a user may determine whether the transmitter 502 complies with the buffer model based on the buffer model saved in the memory 110, as well as the determined network delay in operation 704. To do so, the buffer model compliance unit 104 may convert the network delay to a number of packets, and that number of packets is added to the buffer fullness value calculated for the buffer model. Adding the number of packets to the buffer fullness value actually calculated for the buffer model, compensates the buffer model to adjust for the network delay. The test and measurement instrument 100 may display the buffer fullness value as measured and as compensated using the network delay. Alternatively, rather than adding the number of packets to the buffer fullness value, the number of packets may be added or subtracted from the validation thresholds set out by the buffer model. That is, the buffer model compliance unit 104 may shift the validation thresholds based on the network delay.

As an example, the buffer model compliance unit 104 may receive a number of packets and the network delay measurement unit 106 may determine a transit delay of 40 μs on streams with 8 μs of mean packet times. A compensation value may then be determined by dividing the amount of delay by the amount of time between packets, to determine how many packets are within in the delayed time period. In this example, in a 40 μs delay, there would be five packets, which indicate a five packet shift that can be added to the buffer fullness value. An uncompensated buffer model may show the buffer fullness going to negative three, with a limit of zero. However, when the compensation is added back in, the transmitter would be shown as compliant, since the buffer fullness would be two instead of negative three.

Alternatively, rather than adding the network delay to the buffer fullness value, the test and measurement unit may shift the validation thresholds for the buffer model. For example, the buffer model may set the validation thresholds at 0 and 8. That is, the buffer fullness value should not go below 0 or above 8. The buffer model compliance unit 104 may then compensate these values based on the network delay. Using the example above (40 μs on streams with 8 μs of mean packet times), the validation thresholds may be shifted to −5 and 3. Since this takes into account the network delay, as long as the buffer fullness value is within these parameters, a user will know that their transmitter being testing through the network is compliant with the buffer model set out in the standard.

Aspects of the disclosure may operate on particularly created hardware, firmware, digital signal processors, or on a specially programmed computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a computer readable storage medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or computer-readable storage media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, twisted-pair wire cables, fiber-optic cables, air, or any other media suitable for the communication of electrical, optical, Radio Frequency (RF), infrared, acoustic or other types of signals.

### Examples

Illustrative examples of the technologies disclosed herein are provided below. An embodiment of the technologies may include any one or more, and any combination of, the examples described below.

Example 1 a test and measurement instrument, comprising one or more ports configured to receive a stream of packets from a transmitter through a network component, each packet including a timestamp; and one or more processors configured to: select a buffer model, the buffer model including one or more validation thresholds for a buffer fullness; perform a buffer analysis based on the selected model and the stream of packets; determine a network delay based on the timestamp in each packet and when the packet was received at the one or more ports, and compensate the buffer model based on the network delay to determine a buffer fullness value based on the stream of packets; and a display configured to display an indication of whether the transmitter complies with the selected buffer model.

Example 2 is the test and measurement instrument of example 1, wherein the one or more processors are further configured to convert the network delay to a number of packets based on a mean time between packets and compensate the buffer model based on the number of packets.

Example 3 is the test and measurement instrument of example 2, wherein the one or more processors are further configured to compensate the buffer model by adjusting the one or more validation thresholds for the buffer fullness based on the number of packets.

Example 4 is the test and measurement instrument of example 3, wherein adjusting the one or more validation thresholds for the buffer fullness based on the number of packets includes subtracting the number of packets from the one or more validation threshold.

Example 5 is the test and measurement instrument of example 2, wherein the one or more processors are further configured to compensate the buffer model by modifying the buffer fullness value based on the number of packets.

Example 6 is the test and measurement instrument of example 5, wherein modifying the buffer fullness value includes adding the number of packets to the buffer fullness value determined based on the stream of packets.

Example 7 is the test and measurement instrument of any one of examples 1-7, further comprising a memory to store a plurality of buffer models, and the one or more processors are further configured to select the buffer model from the memory based on an input from a user.

Example 8 is a method, comprising receiving a stream of packets from a transmitter through a network component, each packet including a timestamp; selecting a buffer model for the transmitter, the buffer model including one or more validation thresholds for a buffer fullness; performing a buffer analysis based on the selected buffer model and the stream of packets; determining a network delay based on the timestamp in each packet and when the packet was received at the one or more ports; and compensating the buffer model based on the network delay to determine a buffer fullness value based on the stream of packets.

Example 9 is the method example 8, further comprising converting the network delay to a number of packets based on a mean time between packets and compensating the buffer model based on the number of packets.

Example 10 is the method of example 9, in which compensating the buffer model includes adjusting the one or more validation thresholds for the buffer fullness based on the number of packets.

Example 11 is the method of example 10, wherein adjusting the one or more validation thresholds for the buffer fullness based on the number of packets includes subtracting the number of packets from the one or more validation threshold.

Example 12 is the method of example 9, in which compensating the buffer model includes modifying the buffer fullness value based on the number of packets.

Example 13 is the method of example 12, wherein modifying the buffer fullness value includes adding the number of packets to the buffer fullness value determined based on the stream of packets.

Example 14 is the method of any one of examples 8-13, further comprising storing a plurality of buffer models in a memory, and selecting the buffer model from the memory based on an input from a user.

Example 15 is one or more computer-readable storage media comprising instructions, which, when executed by one or more processors of a test and measurement instrument, cause the test and measurement instrument to: receive a stream of packets from a transmitter through a network component, each packet including a timestamp; select a buffer model based on the transmitter, the buffer model including one or more validation thresholds for a buffer fullness; perform a buffer analysis based on the selected buffer model and the stream of packets; determine a network delay based on the timestamp in each packet and when the packet was received at the one or more ports; and compensate the buffer model based on the network delay to determine a buffer fullness value based on the stream of packets.

Example 16 is the one or more computer-readable storage media of example 15, further comprising instructions to cause the test and measurement instrument to convert the network delay to a number of packets based on a mean time between packets and compensating the buffer model based on the number of packets.

Example 17 is the one or more computer-readable storage media of example 16, further comprising instructions to cause the test and measurement instrument to compensate the buffer model by adjusting the one or more validation thresholds for the buffer fullness based on the number of packets.

Example 18 is the one or more computer-readable storage media of example 17, wherein adjusting the one or more validation thresholds for the buffer fullness based on the number of packets includes subtracting the number of packets from the one or more validation threshold.

Example 19 is the one or more computer-readable storage media of example 16, further comprising instructions to cause the test and measurement instrument to compensate the buffer model by modifying the buffer fullness value based on the number of packets.

Example 20 is the one or more computer-readable storage media of example 19, wherein modifying the buffer fullness value includes adding the number of packets to the buffer fullness value determined based on the stream of packets.

The previously described versions of the disclosed subject matter have many advantages that were either described or would be apparent to a person of ordinary skill. Even so, these advantages or features are not required in all versions of the disclosed apparatus, systems, or methods.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention. Accordingly, the invention should not be limited except as by the appended claims.

I claim:

1. A test and measurement instrument, comprising:
one or more ports configured to receive a stream of packets from a transmitter through a network component, each packet including a timestamp; and
one or more processors configured to:
select a buffer model, the buffer model including one or more validation thresholds for a buffer fullness;
perform a buffer analysis based on the selected model and the stream of packets;
determine a network delay based on the timestamp in each packet and when the packet was received at the one or more ports, and
compensate the buffer model based on the network delay to determine a buffer fullness value based on the stream of packets; and
a display configured to display an indication of whether the transmitter complies with the selected buffer model.

2. The test and measurement instrument of claim 1, wherein the one or more processors are further configured to convert the network delay to a number of packets based on a mean time between packets and compensate the buffer model based on the number of packets.

3. The test and measurement instrument of claim 2, wherein the one or more processors are further configured to compensate the buffer model by adjusting the one or more validation thresholds for the buffer fullness based on the number of packets.

4. The test and measurement instrument of claim 3, wherein adjusting the one or more validation thresholds for the buffer fullness based on the number of packets includes subtracting the number of packets from the one or more validation threshold.

5. The test and measurement instrument of claim 2, wherein the one or more processors are further configured to compensate the buffer model by modifying the buffer fullness value based on the number of packets.

6. The test and measurement instrument of claim 5, wherein modifying the buffer fullness value includes adding the number of packets to the buffer fullness value determined based on the stream of packets.

7. The test and measurement instrument of claim 1, further comprising a memory to store a plurality of buffer models, and the one or more processors are further configured to select the buffer model from the memory based on an input from a user.

8. A method, comprising:
receiving a stream of packets from a transmitter through a network component, each packet including a timestamp;
selecting a buffer model for the transmitter, the buffer model including one or more validation thresholds for a buffer fullness;
performing a buffer analysis based on the selected buffer model and the stream of packets;
determining a network delay based on the timestamp in each packet and when the packet was received at the one or more ports; and
compensating the buffer model based on the network delay to determine a buffer fullness value based on the stream of packets.

9. The method of claim 8, further comprising converting the network delay to a number of packets based on a mean time between packets and compensating the buffer model based on the number of packets.

10. The method of claim 9, in which compensating the buffer model includes adjusting the one or more validation thresholds for the buffer fullness based on the number of packets.

11. The method of claim 10, wherein adjusting the one or more validation thresholds for the buffer fullness based on the number of packets includes subtracting the number of packets from the one or more validation thresholds.

12. The method of claim 9, in which compensating the buffer model includes modifying the buffer fullness value based on the number of packets.

13. The method of claim 12, wherein modifying the buffer fullness value includes adding the number of packets to the buffer fullness value determined based on the stream of packets.

14. The method of claim 8, further comprising storing a plurality of buffer models in a memory, and selecting the buffer model from the memory based on an input from a user.

15. One or more computer-readable storage media comprising instructions, which, when executed by one or more processors of a test and measurement instrument, cause the test and measurement instrument to:
receive a stream of packets from a transmitter through a network component, each packet including a timestamp;
select a buffer model based on the transmitter, the buffer model including one or more validation thresholds for a buffer fullness;
perform a buffer analysis based on the selected buffer model and the stream of packets;
determine a network delay based on the timestamp in each packet and when the packet was received at the one or more ports; and
compensate the buffer model based on the network delay to determine a buffer fullness value based on the stream of packets.

16. The one or more computer-readable storage media of claim 15, further comprising instructions to cause the test and measurement instrument to convert the network delay to a number of packets based on a mean time between packets and compensating the buffer model based on the number of packets.

17. The one or more computer-readable storage media of claim 16, further comprising instructions to cause the test and measurement instrument to compensate the buffer model by adjusting the one or more validation thresholds for the buffer fullness based on the number of packets.

18. The one or more computer-readable storage media of claim 17, wherein adjusting the one or more validation thresholds for the buffer fullness based on the number of packets includes subtracting the number of packets from the one or more validation threshold.

19. The one or more computer-readable storage media of claim 16, further comprising instructions to cause the test and measurement instrument to compensate the buffer model by modifying the buffer fullness value based on the number of packets.

20. The one or more computer-readable storage media of claim 19, wherein modifying the buffer fullness value includes adding the number of packets to the buffer fullness value determined based on the stream of packets.
